(19) United States
(12) Patent Application Publication
(10) Pub. No.: US 2023/0311279 A1
(43) Pub. Date: Oct. 5, 2023

(54) TOOL CONNECTOR

(71) Applicant: SHIN YING ENTPR CO., LTD., Taichung City (TW)

(72) Inventor: WEN-HUNG CHIANG, Taichung City (TW)

(21) Appl. No.: 17/706,899

(22) Filed: Mar. 29, 2022

(51) Int. Cl. B25B 23/00

(52) U.S. Cl. CPC B25B 23/0035

(57) ABSTRACT

A tool connector is provided, including: a main body, including a connection portion including a through hole, a blocking member being movably received in the through hole; an adapter member, inserted in the main body and movable between a first position and a second position, wherein when the adapter member is located in the first position, the adapter member is abutted radially against the blocking member so that the blocking member is urged outwardly, and when the adapter member is located in the second position, the blocking member is not urged outwardly by the adapter member so that the blocking member is inwardly movable; an elastic member, disposed between the main body and the adapter member, urging the adapter member toward the first position; at least one detent member, disposed on the main body, configured to block the adapter member from detaching from the main body.

### BACKGROUND OF THE INVENTION

### Field of the Invention

The present invention relates to a tool connector.

### Description of the Prior Art

Generally, during fastening operation, a pneumatic or electric rotational tool is assembled to a fastener for fastening or the like. The driving end of the conventional rotational tool includes a driving rod, and the driving rod is engaged with and drives the fastener. The driving end rotates to drive the driving rod to rotate, to perform the fastening operation. However, there are many types of fasteners (such as screws, nuts and bolts, or the like), so it is necessary to replace different drive rods for different types of fasteners, and thus it is very inconvenient to use.

The present invention is, therefore, arisen to obviate or at least mitigate the above-mentioned disadvantages.

### SUMMARY OF THE INVENTION

The main object of the present invention is to provide a tool connector which provides adaption to a rotational tool or a driving tool.

To achieve the above and other objects, a tool connector is provided, including: a main body, including a connection portion, the connection portion including a through hole extending radially therethrough, a blocking member being movably received in the through hole; an adapter member, inserted in the main body and movable between a first position and a second position, wherein when the adapter member is located in the first position, the adapter member is abutted radially against the blocking member so that the blocking member is urged outwardly, and when the adapter member is located in the second position, the blocking member is not urged outwardly by the adapter member so that the blocking member is inwardly movable; an elastic member, disposed between the main body and the adapter member, urging the adapter member toward the first position; at least one detent member, disposed on the main body, configured to block the adapter member from detaching from the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIGS. 3 and 4 are cross-sectional views showing operation of a preferable embodiment of the present invention.

### DETAILED DESCRIPTION OF THE PREFERRED EMBODIMENTS

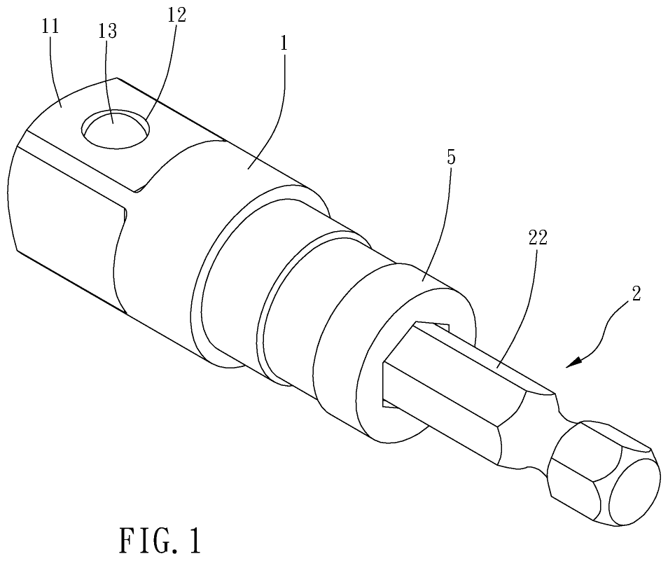

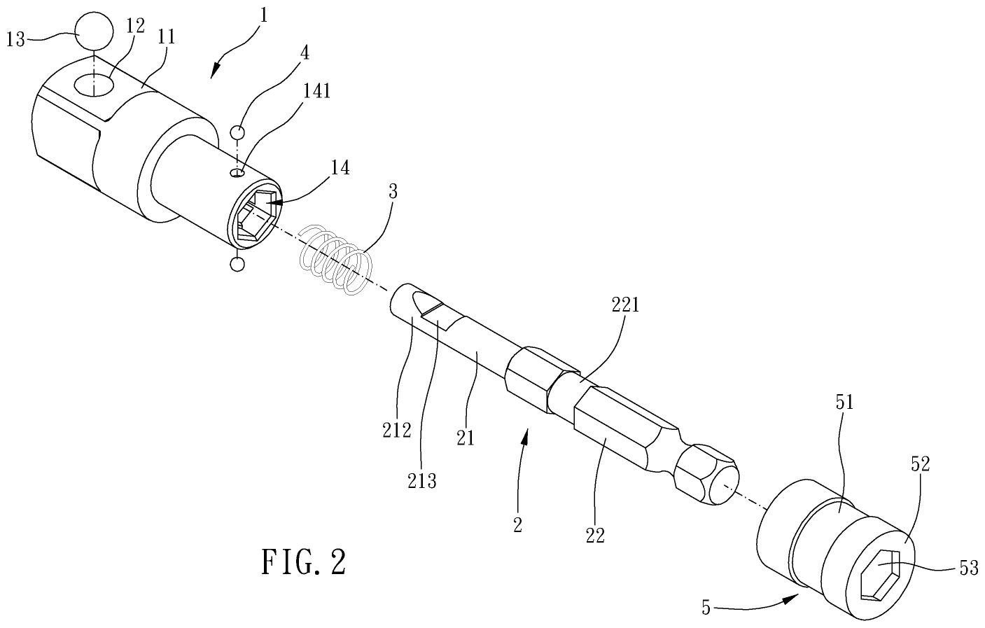

Please refer to FIGS. 1 to 4 for a preferable embodiment of the present invention. A tool connector of the present invention includes a main body 1, an adapter member 2, an elastic member 3 and at least one detent member 4.

The main body 1 includes a connection portion 11, the connection portion 11 includes a through hole 12 extending radially therethrough, and a blocking member 13 is movably received in the through hole 12.

The adapter member 2 is inserted in the main body 1 and movable between a first position and a second position. When the adapter member 2 is located in the first position, the adapter member 2 is abutted radially against the blocking member 13 so that the blocking member 13 is urged outwardly, and when the adapter member 2 is located in the second position, the blocking member 13 is not urged outwardly by the adapter member 2 so that the blocking member 13 is inwardly movable.

The elastic member 3 is disposed between the main body 1 and the adapter member 2 and urges the adapter member 2 toward the first position. In this embodiment, when the adapter member 2 is toward the first position, the adapter member 2 moves toward a direction remote from the connection portion 11. In other embodiments, the first position and the second position may be opposite to each other.

The at least one detent member 4 is disposed on the main body 1 and configured to block the adapter member 2 from detaching from the main body 1. That is, when the adapter member 2 is located in the first position, the detent member 4 is blocked with the adapter member 2.

The adapter member 2 further includes an abutting member 21 and a connection rod 22, and the abutting member 21 is connected with the connection rod 22. When the adapter member 2 is located in the first position, the abutting member 21 is abutted radially against the blocking member 13 so that the blocking member 13 is urged outwardly, and when the adapter member 2 is located in the second position, the blocking member 13 is not urged outwardly by the abutting member 21 so that the blocking member 13 is inwardly movable.

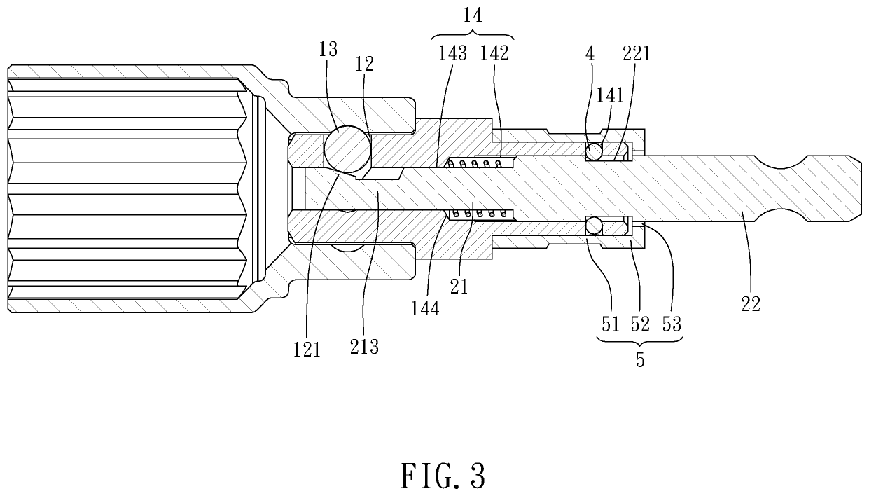

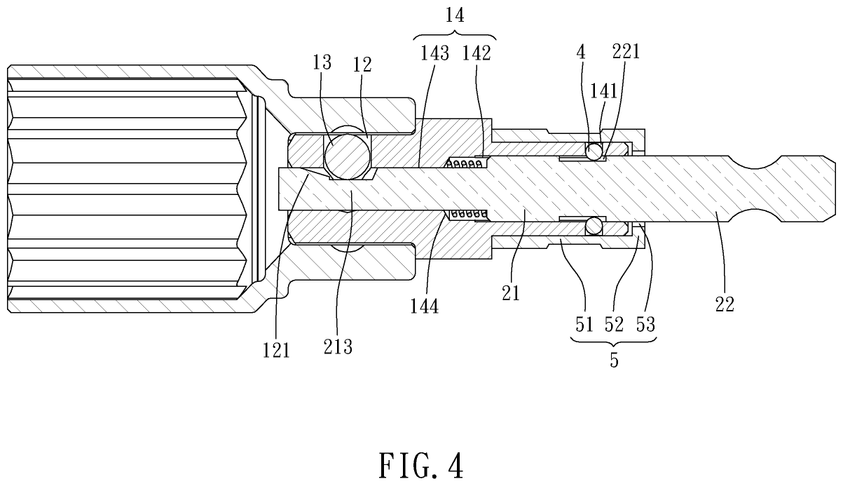

In operation, an end of the connection rod 22 remote from the abutting member 21 is configured to be connected to a rotational tool (such as pneumatic tools or electric tools). When a driving tool (such as a socket shown in FIGS. 3 and 4) is disposed around the connection portion 11 and the adapter member 2 is located in the first position, the blocking member 13 and the driving tool are blocked with each other; as the driving tool is kept being urged toward the main body 1, the main body 1 is clamped by the driving tool and the rotational tool so that the adapter member 2 moves toward the second position and the blocking member 13 moves inwardly, and thus the driving tool is able to be disposed around the connection portion 11, which is convenient in use. When the adapter member 2 is located in the first position, the detent member 4 is blocked with the adapter member 2, which prevents the adapter member 2 from detaching from the main body 1.

Specifically, an end of the main body 1 includes a sleeving hole 14, the adapter member 2 is movably inserted in the sleeving hole 14, and the through hole 12 is in communication with the sleeving hole 14. The main body 1 further includes at least one receiving hole 141 which is lateral to and in communication with the sleeving hole 14, the connection rod 22 includes a second annular groove 221 extending therearound, and the at least one detent member 4 is received in the at least one receiving hole 141 and engaged within the second annular groove 221. In an axial direction of the adapter member, at least one of extents of the at least one receiving hole 141 and the second annular groove 221 is larger than a diametric dimension of the detent member 4, the sleeving hole 14 is non-circular, and the connection rod 22 is non-circular and has a shape corresponding to a shape of the sleeving hole 14. In this embodiment, the extent of the second annular groove 221 is larger than the diametric dimension of the detent member 4, and each of the at least one detent member 4 is a ball member.

Preferably, the tool connector further includes a bush 5, the bush 5 includes a body portion 51 and an upper portion 52 connected with each other, the body portion 51 is disposed around an end of the main body 1 remote from the connection portion 11, the upper portion 52 includes an insertion hole 53, and the connection rod 22 is inserted in the insertion hole 53. The bush 5 can restrict the at least one detent member 4 and prevents the at least one detent member 4 from detaching the receiving hole 141.

The abutting member 21 and the connection rod 22 are integrally formed of one piece, and the connection rod 22 has a diametric dimension larger than a diametric dimension of the abutting member 21, so that the abutting member 21 has a light weight and of low production cost.

Specifically, the sleeving hole 14 includes a large diameter section 142 and a small diameter section 143 which are connected with each other and form a stepped portion 144 therebetween. The elastic member 3 is disposed around a portion of the abutting member 21 inserted within the large diameter section 142 and is abutted against the stepped portion 144 and the connection rod 22, so that the adapter member 2 is urged toward the first position.

Preferably, the abutting member 21 includes an inclined section 212 and a necked section 213, and the inclined section 212 is inclined toward the necked section 213. When the adapter member 2 is located in the first position, the inclined section 212 corresponds to the through hole 12, and when the adapter member 2 is located in the second position, the necked section 213 corresponds to the through hole 12. The inclined section 212 disposed at a side of the necked section 213 remote from the connection rod 22, so that the blocking member 13 is partially received within the necked section 213 and inwardly movable. In this embodiment, the blocking member 13 is a ball member which can move smoothly.

Preferably, the connection portion 11 is disposed at an end of the main body 1, the connection portion 11 has a diametric dimension smaller than a diametric dimension of rest parts of the main body 1, so that the driving tool is able to be positioned; the sleeving hole 14 is disposed through the main body 1, which is advantageous for movement of the adapter member 2 in the sleeving hole 14; an end of the connection rod 22 remote from the abutting member 21 is configured to be connected to the rotational tool, the large diameter section 142 is a hexagonal hole, the connection rod 22 is a hexagonal rod, so that the connection rod 22 is rotatable with the main body 1.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool connector, including:
a main body, including a connection portion, the connection portion including a through hole extending radially therethrough, a blocking member being movably received in the through hole;
an adapter member, inserted in the main body and movable between a first position and a second position, wherein when the adapter member is located in the first position, the adapter member is abutted radially against the blocking member so that the blocking member is urged outwardly, and when the adapter member is located in the second position, the blocking member is not urged outwardly by the adapter member so that the blocking member is inwardly movable;
an elastic member, disposed between the main body and the adapter member, urging the adapter member toward the first position;
at least one detent member, disposed on the main body, configured to block the adapter member from detaching from the main body.

2. The tool connector of claim 1, wherein the adapter member further includes an abutting member and a connection rod, the abutting member is connected with the connection rod, when the adapter member is located in the first position, the abutting member is abutted radially against the blocking member so that the blocking member is urged outwardly, and when the adapter member is located in the second position, the blocking member is not urged outwardly by the abutting member so that the blocking member is inwardly movable.

3. The tool connector of claim 2, wherein an end of the main body includes a sleeving hole, the adapter member is movably inserted in the sleeving hole, the through hole is in communication with the sleeving hole, the main body further includes at least one receiving hole which is lateral to and in communication with the sleeving hole, the connection rod includes a second annular groove extending therearound, the at least one detent member is received in the at least one receiving hole and engaged within the second annular groove, in an axial direction of the adapter member, at least one of extents of the at least one receiving hole and the second annular groove is larger than a diametric dimension of the detent member, the sleeving hole is non-circular, and the connection rod is non-circular and has a shape corresponding to a shape of the sleeving hole.

4. The tool connector of claim 2, wherein the abutting member and the connection rod are integrally formed of one piece, and the connection rod has a diametric dimension larger than a diametric dimension of the abutting member.

5. The tool connector of claim 3, wherein the sleeving hole includes a large diameter section and a small diameter section, the large diameter section and the small diameter section are connected with each other and form a stepped portion therebetween, and the elastic member is disposed around a portion of the abutting member inserted within the large diameter section and is abutted against the stepped portion and the connection rod.

6. The tool connector of claim 2, wherein the abutting member includes an inclined section and a necked section, the inclined section is inclined toward the necked section, when the adapter member is located in the first position, the inclined section corresponds to the through hole, and when the adapter member is located in the second position, the necked section corresponds to the through hole.

7. The tool connector of claim 2, further includes a bush, wherein the bush includes a body portion and an upper portion connected with each other, the body portion is disposed around an end of the main body remote from the connection portion, the upper portion includes an insertion hole, and the connection rod is inserted in the insertion hole.

8. The tool connector of claim 3, wherein the abutting member and the connection rod are integrally formed of one piece, and the connection rod has a diametric dimension larger than a diametric dimension of the abutting member; the sleeving hole includes a large diameter section and a small diameter section, the large diameter section and the small diameter section are connected with each other and form a stepped portion therebetween, and the elastic member is disposed around a portion of the abutting member inserted within the large diameter section and is abutted against the stepped portion and the connection rod; the abutting member includes an inclined section and a necked section, the inclined section is inclined toward the necked section, when the adapter member is located in the first position, the inclined section corresponds to the through hole, and when the adapter member is located in the second position, the necked section corresponds to the through hole; the connection portion is disposed at an end of the main body; the sleeving hole is disposed through; an end of the connection rod remote from the abutting member is configured to be connected to a rotational tool, the large diameter section is a hexagonal hole, and the connection rod is a hexagonal rod; the blocking member is a ball member, and each of the at least one detent member is a ball member; the inclined section is located at a side of the necked section remote from the connection rod.
